(19) United States
(12) Patent Application Publication
(10) Pub. No.: US 2023/0237166 A1
(43) Pub. Date: Jul. 27, 2023

(54) MAINTAINING SECURITY DURING LOCKBOX MIGRATION

(71) Applicant: Dell Products L.P., Round Rock, TX (US)

(72) Inventors: Michael VARTERESIAN, Lexington, MA (US); Muzhar S. KHOKHAR, Shrewsbury, MA (US); Wenfeng LI, Shanghai (CN); Shaojuan LIN, Shanghai (CN)

(73) Assignee: Dell Products L.P., Round Rock, TX (US)

(21) Appl. No.: 17/584,884

(22) Filed: Jan. 26, 2022

(51) Int. Cl. G06F 21/60

(52) U.S. Cl. CPC G06F 21/602

(57) ABSTRACT

An information handling system may include at least one processor and a memory. The information handling system may be configured to: store a cryptographic lockbox that is secured by a first set of secrets and that is accessible from a first virtual machine; modify the cryptographic lockbox such that the cryptographic lockbox is secured based on a second set of secrets that includes a strict subset of the first set of secrets and a user-supplied secret; and access the cryptographic lockbox from a second virtual machine.

### TECHNICAL FIELD

The present disclosure relates in general to information handling systems, and more particularly to providing security during migration of credentials in a cryptographic lockbox.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

HCI systems may implement various types of functionality via VMs of different types (e.g., witness VMs, storage VMs, and management VMs). Each such component often has its own set of credentials (e.g., usernames, passwords, etc.) that are used to perform setup and ongoing management operations.

Storing these credentials enables automated operations that can significantly improve the customer's experience and enable self-healing operations. However, it is important that the credentials be stored securely. Some embodiments store credentials in a cryptographic lockbox (e.g., stored as key-value pairs such as username-password pairs). A cryptographic lockbox is generally implemented as a file that has been encrypted using some cryptosystem. For example, an RSA lockbox uses Rivest-Shamir-Adleman encryption, and other types of lockbox may use other cryptosystems. For purposes of this disclosure, the term “lockbox” should be understood to include any cryptographic data storage that is secured by one or more secrets.

One embodiment stores credentials in a lockbox within each management VM. The credentials should be accessible during normal operations, but they should not be accessible if the lockbox is removed from its original environment or if an unauthorized user gains access to the management VM. Malicious actors may use operations like VM cloning or copying to attempt to gain access to the lockbox, and the lockbox should be resistant to such attempts.

However, there are situations such as disaster recovery and major upgrades that do include the legitimate creation of a new management VM and migration of the existing lockbox to the new VM. The credentials should be accessible after these operations have been completed. However, the steps required for these legitimate operations may be similar to the steps that a malicious actor might employ to try to gain access to the lockbox. Thus embodiments of this disclosure may provide a way of supporting legitimate operations such as those mentioned above, without sacrificing the overall security of the infrastructure.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with securing cryptographic lockboxes may be reduced or eliminated.

In accordance with embodiments of the present disclosure, an information handling system may include at least one processor and a memory. The information handling system may be configured to: store a cryptographic lockbox that is secured by a first set of secrets and that is accessible from a first virtual machine; modify the cryptographic lockbox such that the cryptographic lockbox is secured based on a second set of secrets that includes a strict subset of the first set of secrets and a user-supplied secret; and access the cryptographic lockbox from a second virtual machine.

In accordance with these and other embodiments of the present disclosure, a method may include storing a cryptographic lockbox that is secured by a first set of secrets and that is accessible from a first virtual machine;

modifying the cryptographic lockbox such that the cryptographic lockbox is secured based on a second set of secrets that includes a strict subset of the first set of secrets and a user-supplied secret; and accessing the cryptographic lockbox from a second virtual machine.

In accordance with these and other embodiments of the present disclosure, an article of manufacture may include a non-transitory, computer-readable medium having computer-executable instructions thereon that are executable by a processor of an information handling system for: storing a cryptographic lockbox that is secured by a first set of secrets and that is accessible from a first virtual machine; modifying the cryptographic lockbox such that the cryptographic lockbox is secured based on a second set of secrets that includes a strict subset of the first set of secrets and a user-supplied secret; and accessing the cryptographic lockbox from a second virtual machine.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates migration of a cryptographic lockbox, in accordance with embodiments of the present disclosure.

### DETAILED DESCRIPTION

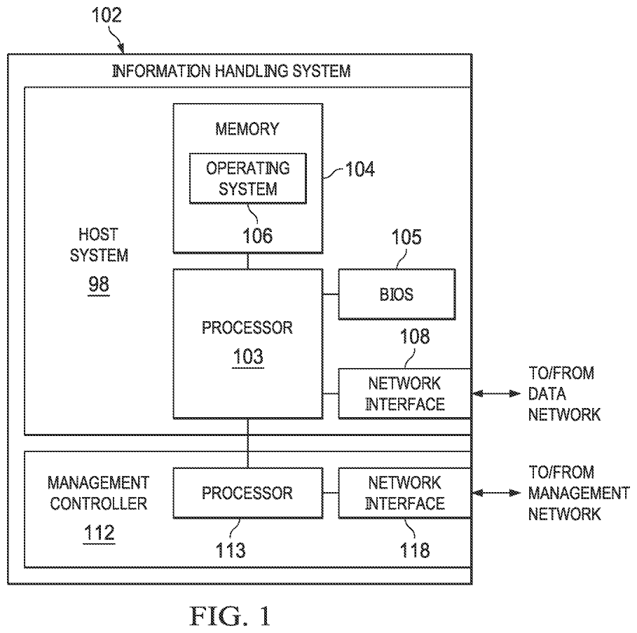

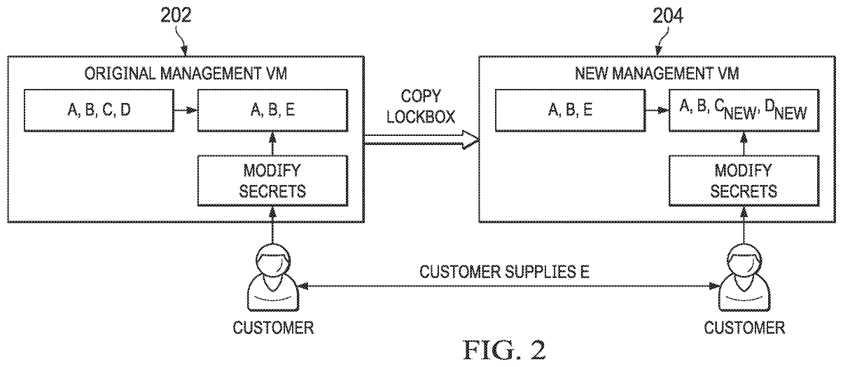

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may provide security for information such as credentials stored in a cryptographic lockbox in the context of a VM migration. Such a migration may include cloning an existing VM and transferring its operations to the new VM.

In one embodiment, a lockbox may be secured by several different pieces of secret data. Typically, the different secrets are combined in such a way that if a lockbox is secured by N secrets, then at least M of them (where M<=N) are required to access the lockbox. For example, in one implementation, N=7 and M=5. This arrangement may be used so that one or two secrets (e.g., properties of the VM hosting the lockbox) may be allowed to change during normal operation, and access to the lockbox will not be revoked. The lockbox may then “self-heal,” with the changed values for those secrets then becoming the current values that secure the lockbox.

The secrets that protect access to a lockbox may include a set of values derived from the local hardware and software that are nearly impossible to duplicate outside of the actual HCI cluster environment. Before an operation that requires the lockbox to be migrated, the secrets may be modified to remove those items that will change as a result of the migration operation. Further, a customer-supplied secret may be added to maintain sufficient integrity. Thus after this procedure, the lockbox is protected based on a new set of secrets that is a (strict) subset of the original set of secrets, together with a new customer-supplied secret.

When the lockbox is later restored on the new VM, the customer may provide that customer-supplied secret, and the remaining secrets may still match, allowing access to the lockbox in the new VM. The customer-supplied secret may then be removed, and the full set of system-based secrets may be restored.

FIG. 2 provides one example of such a migration, according to some embodiments. For the sake of simplicity, in this example, the lockbox is secured by four secrets (N=4). A and B are secrets that are associated with the cluster hardware environment, while C and D are secrets that are associated with the particular management VM instance. The customer may desire to transition from the original management VM 202 to a new management VM 204 (e.g., in the context of a cluster upgrade, etc.). The new management VM 204 may be a cloned version of the original management VM 202 in some embodiments.

When such a VM migration is needed, the HCI management system may unlock the lockbox and then remove secrets C and D. A customer-supplied secret E (e.g., a password, passphrase, string, number, etc.) may be added to the lockbox for additional security. The lockbox may then be encrypted with secrets A, B, and E. The modified version of the lockbox may then be saved.

The migration may then proceed with the creation of a cloned VM as new management VM 204. To access the lockbox in new management VM 204, the customer may provide the secret E, while the secrets A and B may be verified based on the unchanged hardware environment.

The secret E may then be removed from the lockbox, and secrets C and D (with their new, VM-dependent values C_{new} and D_{new} respectively) may be re-added. The lockbox may then be encrypted with secrets A, B, C_{new} and D_{new} and saved.

The migration may then be complete, and the new management VM may maintain access to the lockbox as intended.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
store a cryptographic lockbox that is secured by a first set of secrets and that is accessible from a first virtual machine;
modify the cryptographic lockbox such that the cryptographic lockbox is secured based on a second set of secrets that includes a strict subset of the first set of secrets and a user-supplied secret; and
access the cryptographic lockbox from a second virtual machine.

2. The information handling system of claim 1, wherein the first set of secrets includes at least one value that is specific to the first virtual machine.

3. The information handling system of claim 2, wherein the second set of secrets does not include the at least one value that is specific to the first virtual machine.

4. The information handling system of claim 3, further configured to:
modify the cryptographic lockbox such that the cryptographic lockbox is secured based on a third set of secrets that includes the strict subset of the first set of secrets and a new version of the at least one value, wherein the new version of the at least one value is specific to the second virtual machine.

5. The information handling system of claim 1, wherein the second virtual machine is a cloned version of the first virtual machine.

6. The information handling system of claim 5, wherein the first and second virtual machines are management virtual machines of a hyper-converged infrastructure (HCI) cluster.

7. A computer-implemented method comprising:
storing a cryptographic lockbox that is secured by a first set of secrets and that is accessible from a first virtual machine;
modifying the cryptographic lockbox such that the cryptographic lockbox is secured based on a second set of secrets that includes a strict subset of the first set of secrets and a user-supplied secret; and
accessing the cryptographic lockbox from a second virtual machine.

8. The method of claim 7, wherein the first set of secrets includes at least one value that is specific to the first virtual machine.

9. The method of claim 8, wherein the second set of secrets does not include the at least one value that is specific to the first virtual machine.

10. The method of claim 9, further comprising:
modifying the cryptographic lockbox such that the cryptographic lockbox is secured based on a third set of secrets that includes the strict subset of the first set of secrets and a new version of the at least one value, wherein the new version of the at least one value is specific to the second virtual machine.

11. The method of claim 7, wherein the second virtual machine is a cloned version of the first virtual machine.

12. The method of claim 11, wherein the first and second virtual machines are management virtual machines of a hyper-converged infrastructure (HCI) cluster.

13. An article of manufacture comprising a non-transitory, computer-readable medium having computer-executable instructions thereon that are executable by a processor of an information handling system for:
storing a cryptographic lockbox that is secured by a first set of secrets and that is accessible from a first virtual machine;
modifying the cryptographic lockbox such that the cryptographic lockbox is secured based on a second set of secrets that includes a strict subset of the first set of secrets and a user-supplied secret; and
accessing the cryptographic lockbox from a second virtual machine.

14. The article of claim 13, wherein the first set of secrets includes at least one value that is specific to the first virtual machine.

15. The article of claim 14, wherein the second set of secrets does not include the at least one value that is specific to the first virtual machine.

16. The article of claim 15, wherein the instructions are further executable for:
modifying the cryptographic lockbox such that the cryptographic lockbox is secured based on a third set of secrets that includes the strict subset of the first set of secrets and a new version of the at least one value, wherein the new version of the at least one value is specific to the second virtual machine.

17. The article of claim 13, wherein the second virtual machine is a cloned version of the first virtual machine.

18. The article of claim 17, wherein the first and second virtual machines are management virtual machines of a hyper-converged infrastructure (HCI) cluster.
